(19) United States
(12) Patent Application Publication
(10) Pub. No.: US 2007/0103448 A1
(43) Pub. Date: May 10, 2007

(54) Adaptable keyboard for a tablet PC

(76) Inventor: Steven D. Cook, Tigard, OR (US)

Correspondence Address: Rochelle Lieberman;Lieberman & Brandsdorfer, LLC, 12221 McDonald Chapel Drive, Gaithersburg, MD, 20878-2252, US

(21) Appl. No.: 11/268,202

(22) Filed: Nov. 7, 2005

(51) Int. Cl. G09G 5/00

(52) U.S. Cl. 345/173

(57) ABSTRACT

A system and method are provided for enabling a Tablet PC to receive a keyboard and to communicate depression of keys on the keyboard to an associated operating system. The keys of the keyboard are translucent or transparent. When the keyboard is in an active position, the operating system displays characters on a portion of the display that receives the keyboard. The translucent or transparent characteristic of the keys enables the display characters to project through the keys. At such time as a key is depressed and touches the display, the character associated with the key is communicated to the operating system. Similarly, when the keyboard is in an inactive position, the portion of the Tablet PC that receives the keyboard does not display the characters thereon.

### BACKGROUND OF THE INVENTION

1. Technical Field

This invention relates to a portable personal computer with a touch sensitive display, also known in the industry as a Tablet PC. More specifically, the invention relates to incorporating a portable keyboard with the Tablet PC to enter characters without use of a stylus.

2. Description of the Prior Art

A Tablet PC is a wireless personal computer (PC) that allows a user to take notes using natural handwriting with a stylus or digital pen, hereinafter referred to as a pen, on a touch screen. The Tablet PC is similar in size and thickness to a yellow paper notepad and is intended to function as the user's primary personal computer as well as a note-taking device. The pen may be applied directly on the screen just as you would a conventional computer mouse to select, drag, and open files, or in place of a keyboard to handwrite notes and communication. Software is integrated with the Tablet PC to translate handwritten instructions to computer readable instructions. However, there are drawbacks associated with use of the pen and the associated software. For example, the software that converts the handwritten data to computer readable data is error prone and requires the user to proof their input data. This requires additional time which the user may not have available.

Since conventional personal computer use a keyboard to receive input data, it has become known in the art for Tablet PCs to include a keyboard area. Such Tablet PCs are called convertibles or hybrids. Similarly, Tablet PCs that are only a monitor with a pen are called a slate. Since many PC users are comfortable with a conventional keyboard to input data, hybrid Tablet PCs may also include an integrated keyboard that rotates 180 degrees and can be folded down over the keyboard, or a slate style, with a removable keyboard. However, a drawback with the hybrid table PC is the requirement of a keyboard. Tablet PCs are portable lightweight computers and one of their advantages is that they do not have a keyboard that must be transported with the display. The hybrid has solved a problem with a drawback associated with the table PC, while removing one of the enticing benefits associated therewith.

Therefore, there is a need for a keyboard, virtual or physical, that can be modified for use with a Tablet PC that will not interfere with portability or significantly increase the weight associated with the Tablet PC.

### SUMMARY OF THE INVENTION

This invention comprises a Tablet PC with a keyboard attachment that changes between an active position and an inactive position.

In one aspect, a Tablet computer is provided with a touch sensitive display. A keyboard template is provided to be positioned over a portion of the display. The template includes a plurality of spaced apart openings. A range of pixels of the display are assigned to represent a single character. The range of pixels are illuminated when the keyboard is placed in an active position.

In another aspect of the invention, a computer is provided with a display responsive to touch. A keyboard is provided with a plurality of keys adapted to be positioned over a portion of the display. A range of pixels of the display are assigned to represent a single character.

In yet another aspect of the invention, a method is provided for employing a keyboard with a Tablet PC. A keyboard template is positioned from a storage position to an active position over a portion of a display. A range of pixels of said display are assigned to represent a single character. The character assigned to the pixels is projected through a key of the keyboard. The key is registered with an operating system of the PC responsive to the key touching the display.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a perspective view of a Tablet PC taken from the right side with a keyboard in an active position according to the preferred embodiment of this invention, and is suggested for printing on the first page of the issued patent.

FIG. 2 is a perspective view of a Tablet PC taken from the back side with a keyboard in an inactive position.

FIG. 3 is a flow chart illustrating positioning of the keyboard to communicate characters to the operating system.

### DESCRIPTION OF THE PREFERRED EMBODIMENT

### Overview

A Tablet PC is provided with an optional keyboard implementation. The keyboard is lightweight and sized to fit over a portion of the display of the Tablet PC. In an inactive state, the keyboard may be stored adjacent to a back portion of the Tablet PC. At such time as the keyboard is positioned to cover a portion of the display, the active state of the keyboard is registered with the operating system. Characters are illuminated on the portion of the display that receives the keyboard. The keys of the keyboard are transparent or translucent to allow the character on the display to be displayed through the key to the user.

### Technical Details

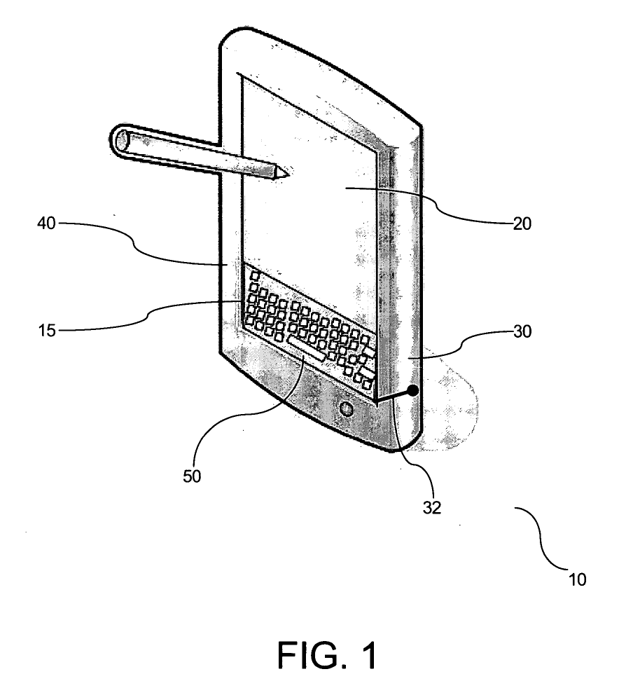

A keyboard sized for the Tablet PC is provided. FIG. 1 is an illustration (10) of a front view of a Tablet PC (20). As shown, the left hand side (30) has a hinge (32). The right hand side (40) also has a hinge (42) (not shown), but it is not visible from this view. The hinges (32) and (42) are placed to support rotation of a keyboard (50) from a storage position to an active position. A switch (15) is shown in the front face of the computer. In one embodiment, the switch (15) may be placed on alternative surface of the computer, such as the right side or left side. The purpose of the switch (15) is to place the keyboard in an active or inactive status with respect to the operating system of the Tablet PC. In an active state, the depression of keys on the keyboard will communicate data from the keyboard to the operating system. Once the keyboard is in an active position, depression of any of the keys associated therewith will input characters on a display portion (20). The keyboard is sized for the Tablet PC and is not sized for a conventional PC. In one embodiment, the keyboard will include all of the keys of a QWERTY keyboard and will have the look and feel of a conventional keyboard. Furthermore, each key on the keyboard may include a translucent or transparent material to enable a character associated with the key to be reflected from the display of the Tablet PC through the key. When the keyboard is placed in an active position relative to the PC, an interface associated with the operating system is activated. In one embodiment, the interface is in the form of a graphical user interface and characters associated with each key illuminate from the display and through the translucent or transparent keys. Accordingly, the position of the keyboard with respect to the PC is communicated to the operating system based upon placement thereof.

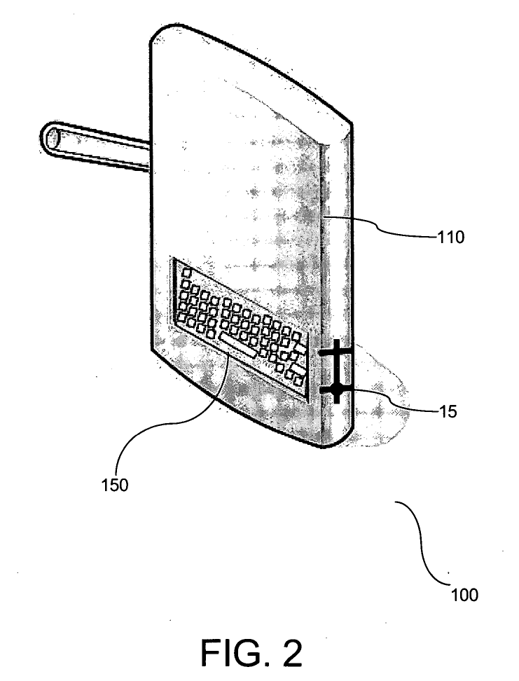

FIG. 2 is an illustration (100) of a back view of the Tablet PC (110) showing the keyboard (150) in a stored position. When the keyboard is in a storage position, the keyboard is in an inactive state and depression of any keys associated therewith will not input character data to the operating system. In one embodiment, an inactive keyboard state will be reflected in a raised position of the switch (15). Depression of any of the keys when the keyboard is in an inactive state will not communicate data to the operating system. Accordingly, activation of the switch (15) reflects the position of the keyboard to the operating system and also controls communication from the keyboard.

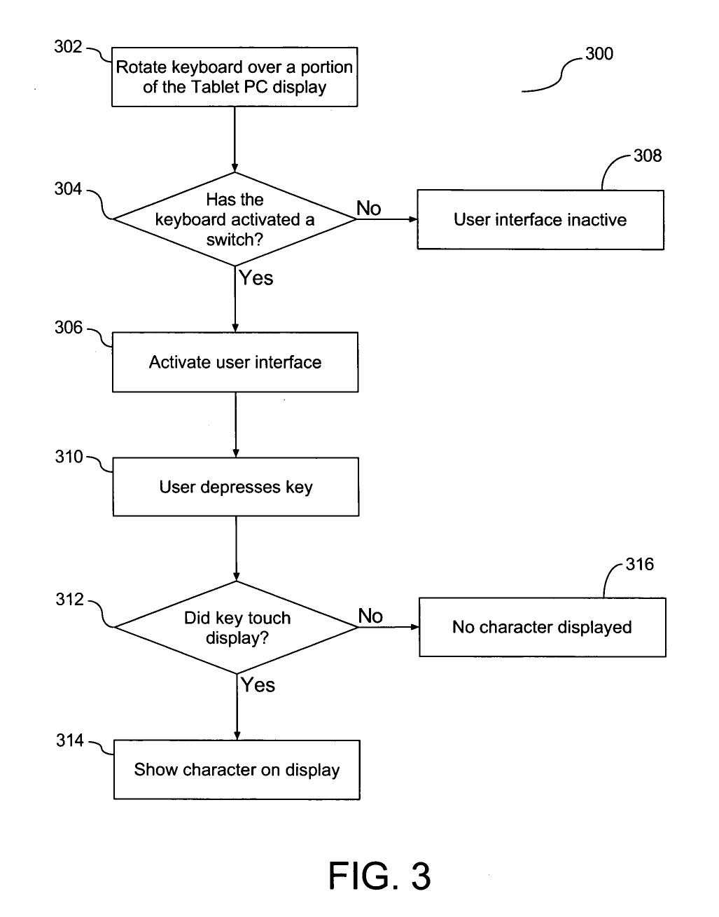

FIG. 3 is a flow chart (300) illustrating the process of activating the keyboard of the Tablet PC. In a first step, the keyboard is rotated into a position over a portion of the display of the Tablet PC (302). A test is conducted to determine if positioning of the keyboard has activated a switch that communicates with the user interface (304). In one embodiment, activation of the user interface is dependent upon activation of the switch (15). However, in an alternative embodiment, activation of the user interface may be independent of the switch (15). For example, a user may execute software to activate the user interface around the time the keyboard is placed over a portion of the display of the TabletPC. As noted above, rotation of the keyboard into an active position communicates with the operating system of the PC. A positive response to the test at step (304) will activate the user interface (306), which in turn activates software to exhibit characters across a portion of the display that receives the keyboard. Similarly, a negative response to the test at step (304) will not activate the user interface (308). In one embodiment, each of the keys of the keyboard is transparent or translucent to allow the character on the display to be projected through the keys. As the user depresses each key (310), a test is conducted to determine if a portion of the key touched the surface of the display portion of the Tablet (312). Since the display portion of the Table PC is touch sensitive, a touch of any of the keys to the surface of the display is sufficient to activate communication of a character. A positive response to the test at step (312), enables the operating system to illuminate on the display the character assigned to the associated key (314). Similarly, a negative response to the test at step (312) will not show a character on the keyboard, as the interface will not register a touching of the key to the assigned display portion (316). Accordingly, the touch sensitive display in conjunction with the interface enables the associated characters to be illuminated through the material of the keyboard keys, and it also enables a touch of the key to the display to register the character with the operating system and to display this character on another portion of the display.

### Advantages Over the Prior Art

The position of the keyboard in both the active and stored positions, enables the keyboard to be an unobtrusive addition to the Tablet PC. Similarly, the activation of the keyboard is optional for the user. When the keyboard is in a stored inactive position, it is non-obtrusive to the user. Similarly, when the keyboard is placed in an active position, it only illuminates a portion of the display of the Table PC. The use of the keyboard is optional and may be activated at such time as the user thinks it will be a more efficient communication tool. Since. each of the keys on the keyboard are transparent or translucent, illumination of the characters projects through the keys.

### Alternative Embodiments

It will be appreciated that, although specific embodiments of the invention have been described herein for purposes of illustration, various modifications may be made without departing from the spirit and scope of the invention. In particular, with respect to the keyboard and its position with respect to the Tablet PC, clips, or an equivalent mechanical device, may be substituted for the hinges shown in the drawing figures and associated detailed description. A clip would be placed along the Tablet PC and would communicate the physical position of the keyboard to the operating system. Furthermore, with respect to the keyboard and it's characters, since the keyboard keys are transparent or translucent, a program may be executed that will illuminate characters of the QWERTY keyboard in a different order or configuration. Similarly, a program may be executed that enables the characters of the keyboard to be from the English language, a foreign language other than English, foreign language characters, phonetic symbols, and typographical symbols. The characters associated with the keys can be assigned to be buttons or symbols for use in games or other types of programs that need buttons and are unrelated to traditional keyboard characters. Accordingly, the scope of protection of this invention is limited only by the following claims and their equivalents.

I claim:

1. A Tablet computer comprising:
a touch sensitive display;
a keyboard template adapted to be positioned over a portion of said display;
said template having a plurality of spaced apart openings; and
a range of pixels of said display assigned to represent a single character.

2. The computer of claim 1, further comprising a translucent material adapted to fill said openings.

3. The computer of claim 2, wherein said translucent material is molded to represent a shape of a key from a conventional computer keyboard.

4. The computer of claim 2, further comprising a graphical user interface adapted to project an image of said character through said translucent material.

5. The computer of claim 4, wherein said graphical user interface projects said image of said character when said template is position over said portion of said display.

6. The computer of claim 1, further comprising a hinge to enable said template to rotate between an operable position over a portion of said display and a storage position.

7. The computer of claim 1, further instructions adapted to reassign said range of pixels to a different character.

8. A computer comprising:
a display responsive to touch;
a keyboard having a plurality of keys and adapted to be positioned over a portion of said display; and
a range of pixels of said display assigned to represent a single character; and
said range of pixels illuminated when the keyboard is placed in an active position.

9. The computer of claim 8, further comprising a switch adapted to communicate an active state of said keyboard to an operating system interface.

10. The computer of claim 8, wherein said key having a material selected from a group consisting of: translucent and transparent.

11. The computer system of claim 10, further comprising a graphical user interface adapted to project an image of said character through said material.

12. The computer system of claim 8, further comprising instructions for changing said character assigned to said range of pixels.

13. The computer system of claim 12, wherein said character is selected from a group consisting of: English language letters, foreign language letters, foreign language characters, phonetic characters and symbols, typographical symbols, and combinations thereof.

14. A method for employing a keyboard with a Tablet PC comprising:
positioning a keyboard template from a storage position to an active position over a portion of a display;
assigning a range of pixels of said display to represent a single character;
projecting said character through a key of said keyboard; and
registering said key with an operating system of said PC responsive to said key touching said display.

15. The method of claim 14, wherein the step of positioning a keyboard template to an active position causes an image of a keyboard to be displayed on the portion of the display adapted to receive the keyboard.

16. The method of claim 14, wherein said key is comprised of a material selected from a group consisting of: transparent and translucent.

17. The method of claim 14, further comprising placing said keyboard template in an inactive position when rotating said keyboard template to a storage position.

18. The method of claim 17, wherein the step of rotating said keyboard template to a storage position removes an image of said keyboard on the portion of the display adapted to receive the keyboard.

19. The method of claim 14, further comprising reassign said range of pixels to a different character.

20. The method of claim 19, wherein said image of said keyboard is selected from a group consisting of: English language letters, foreign language letters, foreign language characters, phonetic characters and symbols, typographical symbols, and combinations thereof.
